(19) United States
(12) Patent Application Publication
(10) Pub. No.: US 2001/0032134 A1
(43) Pub. Date: Oct. 18, 2001

(54) E-commerce mall system

(76) Inventor: Laurence D. Hardesty, Buckeye, AZ (US)

Correspondence Address: Gregory J. Nelson, NELSON & ROEDIGER, Suite 212, 3333 E. Camelback Road, Phoenix, AZ, 85018, US

(21) Appl. No.: 09/796,009

(22) Filed: Feb. 28, 2001

Related U.S. Application Data
(60) Provisional application No. 60/185,990, filed on Mar. 1, 2000.

(51) Int. Cl. G06F 17/60

(52) U.S. Cl. 705/14; 705/27

(57) ABSTRACT

An e-commerce system in which a participating consumer may purchase goods over the Internet or visit a geographically convenient showroom and make product selections for immediate or deferred delivery. Substantial cost benefits result to the manufacturer or supplier which are reflected in rebates to the consumer, preferably paid into an investment account or used for purposes such as reducing existing credit card balances. Service providers may also participate.

This application is based on provisional patent application Ser. No. 60/185,990, entitled “E-Commerce Mall System,” filed Mar. 1, 2000.

### FIELD OF THE INVENTION

The present invention relates to an electronic commerce system more particularly to an Internet-based commerce system which has geographically convenient showrooms at which consumers may either inspect goods for later purchase on the Internet or purchase for immediate fulfillment.

### BACKGROUND OF THE INVENTION

With the wide acceptance of the Internet, various systems of E-Commerce have been developed. Basically, E-Commerce involves the advertising of goods and services on the Internet at various web sites. The consumer may access the web site via the Internet and obtain information and make a product selection. Usually the purchase is made by the consumer using a credit card with the consumer transmitting the order, credit card number and identification, and customer information by e-mail to the manufacturer or merchant. The goods are generally delivered directly to the address designated by the consumer by a common carrier such as UPS.

As a result of the popularity of such systems, mail order merchants such as Homedelivery.com have been developed which provide a shopping site that allows the consumer the convenience of shopping at local merchants. Items such as flowers, groceries, and prescriptions can be ordered via the Internet. The shopping service offers a personalized page that maintains files for easy point-and-click access.

Another popular web site for the purchase of various goods is Ebay. Ebay offers a site on which individuals may place items for purchase by auction. Interested customers can visit the web site browser and select items of interest and submit a bid, which may be accepted. The transaction is a transaction between the seller and the buyer.

There are other systems for delivering consumer-related product information using the Internet. For example, U.S. Pat. No. 5,950,173 shows a system for providing product-related information over the Internet to consumers in retail shopping environments. The system includes Internet information servers which store information pertaining to universal product codes with a list of URLs. Upon entering the UPC number using an Internet browser, a menu of the URLs associated with the entered UPC numbers is displayed for the user. The menu may include product information, including specifications, operation manuals, product wholesalers and retailers, product updates, reviews, warranty and servicing information and the like.

While the Internet has been embraced by many and provides consumers a great deal of convenience and time saving by allowing consumers to shop from their home using the Internet, many consumers resist using the Internet. Current statistics show that approximately two-thirds (⅔) of American consumers are reluctant to use the Internet because of various concerns relating to security, as “hackers” using sophisticated software sometimes gain access to customers' credit card information. Another concern is that many purchasers are reluctant to buy items without physically inspecting the items prior to the purchase.

### BRIEF SUMMARY OF THE INVENTION

Accordingly, the present invention provides an E-Commerce system which utilizes the Internet, but also includes a local or regionalized showroom feature. Participating merchants are linked to a web page and may be selected by name or by type of services or goods. A consumer may easily access the web site and browse looking for a particular merchant or type of goods or services. Since the system is localized, both larger national chains, as well as smaller local businesses, may participate.

In accordance with the system of the invention, a showroom is located in a geographically convenient location such as a local mall and even may be an established store such as a home improvement store, furniture store, warehouse or the like. The showrooms are located in different geographical areas which geographical areas may be cities, towns, subdivisions such as existing shopping areas or zones, zip codes or any other convenient subdivision. The showrooms display various goods which are available for purchase and the showrooms will also provide catalogs from which the consumer may make a selection either for immediate or deferred delivery or fulfillment. The consumer may then visit the showroom and inspect the goods and make a selection. The consumer may place an order for the goods at the showroom using any form of payment. A web site will also provide product, service and other information. The consumer may make a purchase directly on the Internet. The order is then forwarded directly to the manufacturer or wholesaler who will then ship the goods directly to the consumer. Substantial savings result as multiple retail locations are not required. Inventory flooring and stocking charges are eliminated. The manufacturer may produce on receipt of the order and ship directly to the consumer and retail flooring charges are avoided. The consumer may also purchase goods at the showroom or at a local merchant for immediate delivery, but the rebate will be less as the savings to the manufacturer and merchant are less.

Because of the substantial savings realized in the chain of distribution, the system may provide various incentives to customers in the form of rebates. These rebates may be credited directly to a consumer, but preferably are credited to an investment account as more fully described in my U.S. Pat. No. 6,105,65. Rebates may also, at the election of the consumer, be directed to other purposes such as charities, brokerage account or into checking or savings accounts.

### BRIEF DESCRIPTION OF THE DRAWINGS

The above and other objects and advantages of the present invention will be more fully appreciated from the following description, claims and drawings in which:

FIG. 1 is a flow chart illustrating the E-Commerce System of the present invention;

FIG. 2 is a flow chart illustrating the rebate features of the system; and

FIG. 3 depicts a typical web site menu.

### DETAILED DESCRIPTION OF THE DRAWINGS

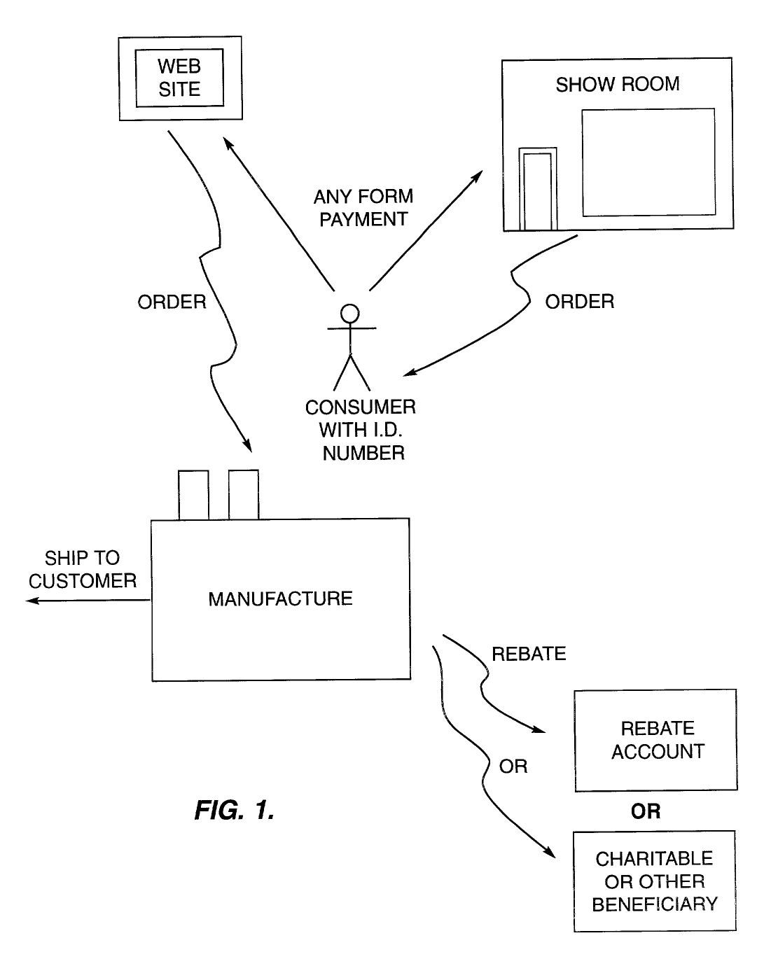

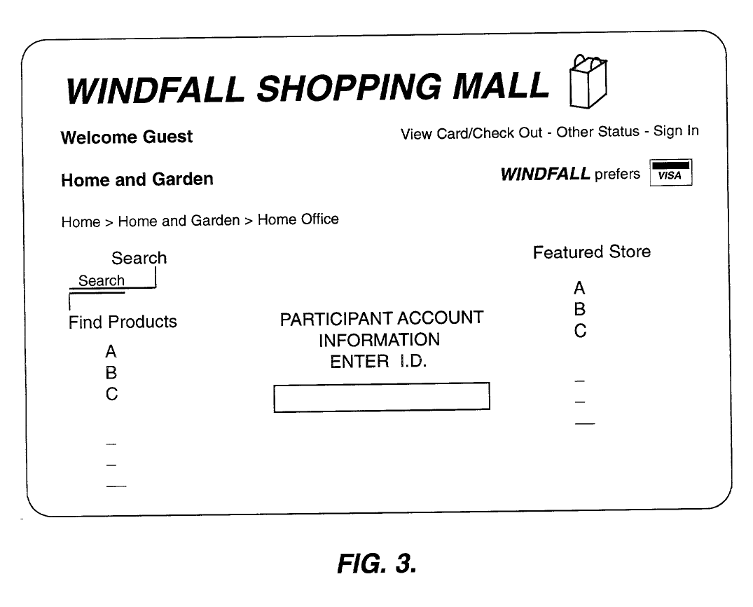

Turning now to the drawings, FIG. 1 illustrates the E-Commerce System of the present invention generally designated by the numeral 10. The system relies upon the global computer communications network known as the Internet. Located on the Internet at a selected URL or address such as www. WindfallMall. com is a web site 12 which has a menu listing participating merchants and also itemizing various types of goods of services available to consumers using the system. Representative web site home pages are shown in FIG. 3. The consumer may select a language when logging on. The consumer will select a particular merchant service provider, manufacturer or type of goods as for example appliances provided by a certain manufacturer 14. The consumer is then linked to a web site which displays the products and provides product and service information available on the system, specifications, consumer reviews, warranty information, incentive programs and pricing. The consumer will be able to order the product directly from the web site by entering the necessary information concerning the product, consumer delivery and credit card information. The system will allow the consumer a personalized page which maintains customer identification, delivery details and credit information on file which can be transmitted conveniently. Each participating consumer is provided a unique account or identification number and the identification of the participating consumer may be verified by the identification number or by a biometric tag such as a facial scan, retinal scan, or fingerprint.

The purchase is consummated and the order transmitted to the manufacturer and direct shipment to the consumer is scheduled by the manufacturer. The customer is advised of the shipping information by e-mail. A savings to the manufacturer results because the manufacturer receives immediate payment and does not maintain unnecessary inventory. A rebate in favor of the consumer may be calculated and distributed to the consumer in the manner described below.

While the above aspect to the system is basically available today, many consumers are reluctant to utilize direct purchase on the Internet because of security issues and inability to physically inspect the goods. Direct purchase via the web may be more secure by providing the consumer a smart card with security encrypted protection. The smart card may also include the necessary information concerning the consumer delivery and other information and this information can be transmitted to the manufacturer by means of a modem of the type currently provided to consumers such as those holding the American Express Blue Card.

If the consumer makes a preliminary selection by surfing the web site, the consumer may then visit the showroom location 20 most convenient to the consumer. By at first utilizing the web site, much of the time normally required making a purchase, particularly a major purchase such as an expensive appliance, can be eliminated. Product information such as pricing, warranty, specifications, consumer ratings can be reviewed and the selection narrowed to perhaps one or two items. Catalog information may be downloaded and printed to allow the customer to review a product line of, for example, refrigerators. The participant may then access information relating to locations where the physical item may be viewed.

The showrooms 20 are located in geographically convenient locations such as existing malls in larger metropolitan areas or in more rural areas within geographical subdivisions such as within centrally located communities within a county or township. The showroom locations would also have access to the Internet site locations and, further, carry display models of the various items that are available by purchase, as well as catalogs. For example, appliances, housewares, clothing items and the like would be on display. This would allow the consumer who has made the preliminary buying decision based on the Internet site to physically inspect the goods and confirm the selection made or make some alternate selection.

Once the selection is made, the consumer may then place the order at the showroom using any suitable form of payment such as cash, check or credit card. The showroom will then transmit the order directly to the manufacturer and or warehouse which will arrange for shipment of the item to the address or location directed by the consumer. Because, as pointed out above, substantial savings result to the supplier, as restocking, flooring and inventory costs are eliminated or at least minimized. The consumer participating in this system may then be credited a rebate, which may be sent directly to the consumer, but preferably which rebate is deposited into an investment account 25 available to the consumer upon the occurrence of an event at a later date such as upon retirement. Preferably the participant is provided with a point-of-sale receipt which indicates the amount of the rebate and also set forth the future value of the rebate, for example, at a time when the participant is eligible to retire. This will promote loyalty. The account preferably would be an interest bearing account which, if the rebates are allowed to accumulate over a period of time, would benefit from the magic of compound interest and could accumulate to a substantial sum. The account may be an established account such as a savings, investment, retirement security or a government employee account. The system will provide the consumer a large selection of local and global products and service so that substantial rebates will be available.

Alternatively, the consumer may purchase some items at the showroom for immediate delivery or pick-up at the time of purchase. As to these, a lesser rebate will apply since the suppliers do not realize as great a savings in inventory and flooring costs. Similarly, some merchants may elect not to participate in the showroom and customers may purchase at a local merchant's business location such as a local appliance dealer. Smaller merchants which sell directly to participating consumers will be entitled to manufacturer's credits based on sales in the merchant's area to encourage and support the smaller merchant.

Consumers at the viewing showroom may elect to purchase an item for immediate delivery which could be made available from an adjacent or area showroom warehouse. The consumer may select other items for future delivery which will be shipped to the consumer at a later date. The rebates may vary with the greater rebate applying to those items which are to be fulfilled at a later date as the suppliers costs such as stocking, floor space and the like are reduced as to those items on which fulfillment is to occur at a later date. The showroom also provides a convenient location for the consumer to seek information warranty service and return goods if necessary.

The consumer may be provided a wireless terminal device by the showroom during shopping. Wireless hand-held devices of this type are known and are used for inventory control and point-of-sale transactions. This device will allow the consumer to enter identification and account information. The consumers may make selections by scanning codes such as UPC codes on displayed items and select either a “purchase now” or “fulfill later” option. The consumers account will be billed or debited on check out and the order information transmitted to the warehouse or manufacturer. Items purchased for immediate delivery will be retrieved and made immediately available. The “fulfill later” items will be ordered from the warehouse or manufacturer and the consumer advised of estimated shipping dates.

The system also contemplates incentive features to reward participant loyalty. Consumers who utilize the system for a period of time or spend a predetermined amount may qualify for special prices or increased rebates. Similarly, those who bring new, qualifying participants to the system may also be provided additional rewards such as increased rebates, special discounts or other programs.

The system also has the benefit of benefitting merchants by providing special promotions, greater rebates or price reduction during normally slow hours. Consumers purchasing using showrooms or local merchants during these periods will be rewarded with savings benefits. Manufacturers and suppliers may also advertise specials such as sales of excess inventory and overruns in order to quickly dispose of items. The advantage to the merchant is both increased business activity and leveling of demand.

The system utilizes both the Internet and physical showrooms and merchant location, a consumer may participate and receive the benefits of the system without using the Internet. The participating consumer may visit a local showroom or merchant and make product or service selections and obtain a rebate as described. Account and order information will be available by telephone using a code or even by traditional means such as periodic mailed statements.

The system also accommodates sales transactions between participants. System participants may advertise items for sale, both new and used, on the system web site. The items may be advertised for sale by auction similar to Ebay or for an advertised price in a classified on-line advertisement. Since the system provides the sellers to advertise within a more limited geographical area, the buyer may personally inspect the items prior to purchase. If a purchase is consummated, a rebate would be paid by the seller for the benefit of the buyer and processed through the system.

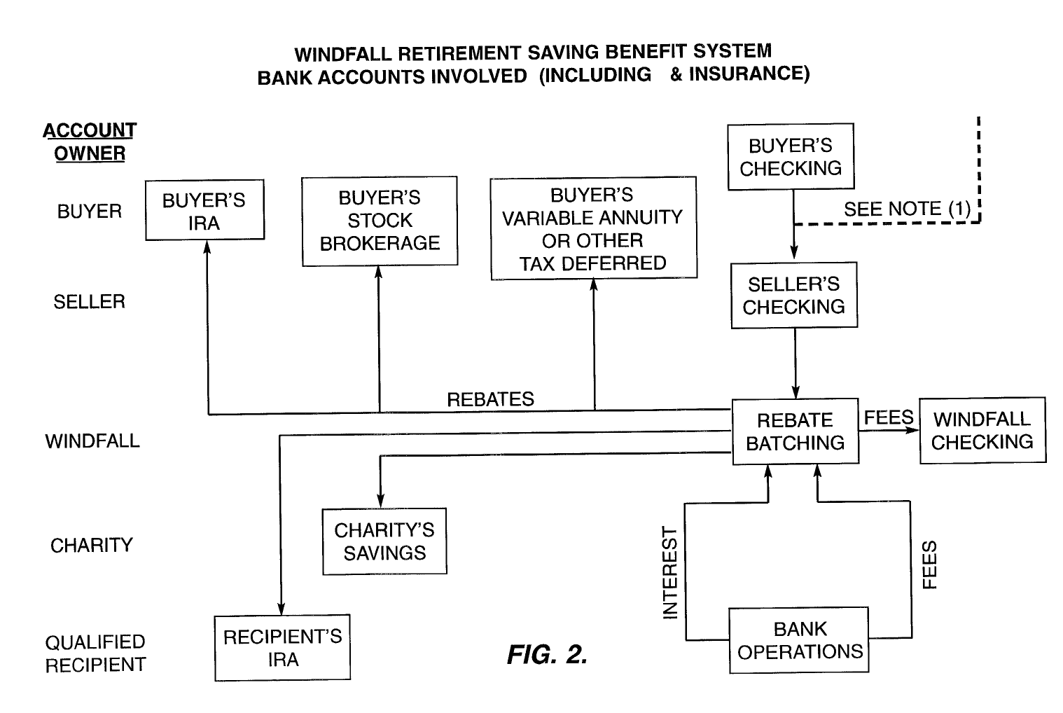

FIG. 2 shows a schematic flow of a rebate that may be received by the buyer. The funds transferred from the buyer as by check or credit card would be deposited into the sellers' checking account. The rebate portion will then be transferred to rebate batching with the appropriate identification of the buyer. The buyer's payment to seller may be cash, check, credit or charge cards, or directly electronic transfer. The buyer's rebates are accumulated until they reach a minimum amount required law such as by the IRA custodian. Once the sums in the batching reach the level they may be distributed in accordance with the direction of the buyer. For example, rebates may be directed to a favorite charity, or religious organization 30. If a buyer designates a recipient who is not qualified for an IRA, those funds may be held in the rebate batcher and are reported in the recipients name at the web site which maintains a record of funds accumulated by the customer. All money in the rebate batcher can be reallocated by the buyer from the web site. The buyer and/or seller may establish an interest bearing checking account at a bank which participates. The bank can offer added benefits. The buyer and bank may agree that the bank may pay interest on the buyer's account in common or preferred stock in lieu of cash. The buyer and seller may agree the bank will pay interest on a seller's account in common or preferred stock in lieu of cash. The stock may be stock in the bank or may be mutually agreed upon listed stock. The bank may also wish to discount the stock. Participants may also be afforded the opportunity to purchase stock of participating merchants at a discount.

While the system that has been described above is with respect to the purchase of goods, providers of services may also participate. Providers of such services would appear as participants on the web page as well as product suppliers. Information regarding location, store hours, special promotions will also be made available to the consumer. These providers of services may be professional services such as doctors, dentists, lawyers and the like. Also insurance and mortgage companies may also participate. Rebates from purchases of services would also flow to the consumer. For example, insurance companies may rebate to insureds periodically if no claims are made for a preceding time period such as a year. Similarly, mortgage companies may provide a rebate because of savings achieved through prompt payment by the mortgagees. Both insurance premiums and mortgage payments could be electronically transferred thus reducing costs of doing business to the service companies. The bank would be a full-service bank and could benefit by buyers using the bank for a normal checking and savings services. Social Security beneficiaries could have their checks electronically deposited in the bank and customers could withdraw from the bank by debit card or establish an electronic bill-paying system.

The participant could use this account to buy securities at a discount. Similarly, employers could agree to wire-transfer their employees paychecks to the bank further resulting in savings both to the bank and the employer.

Similar incentives for sellers exist if sellers use the bank, which is part of the system, or purchases insurance or other services from other participating providers of the system. Such instances, sellers could benefit by rebates, discounts or rebates in kind such as stock.

As mentioned above, participants in this system would be provided a unique account number and can accumulate rebates in the form of cash over a period of time and use. These rebates may be substantial in the range of 2% to 5% much higher than the rebates that can currently being paid by credit card issuers which work on a relatively narrow margin. The system will also facilitate and accommodate use by those who have existing credit cards with a substantial balance. Current figures indicate that many individuals continue to carry a credit balance of about $5,000.00 a year, paying relatively high interest rates of between 15% and 22%. These individuals, in some cases, find it difficult to discipline themselves to fully pay off the card balance. Accordingly, these individuals would be provided a new card identifying them as members of the system. The new card would be a smart card technology, and would not be a credit card. However, a requirement of the issuance of the card and/or their participating in the system would be that these consumers would cancel their existing card and the balance would be transferred to their new card. The new card would carry much lower interest rates than conventional credit cards and the consumers would make purchases using the system described in FIG. 1. However, the consumers would not be permitted to charge additional purchases, but rather could only purchase by paying cash or by electronically debiting their checking account. When making a purchase, they would utilize a smart card which would keep track of purchases and provide budgeting guidelines to assist the cardholders in disciplining their personal finances. Rebates, or a portion of the rebate amount, instead of being deposited into an investment account, would first be used to retire their existing credit card balance. These rebates, coupled with the lower interest rates that these consumers would be charged, would eventually allow their card balances to be retired. Once a card balance is retired, the rebates would then be directed into a depository of the consumer's choice as shown in FIG. 2.

The system of the invention provides the customer the convenience of local shopping and allows both large national chains and small local merchants to participate. The system benefits consumers providing greater purchasing choices, more information on which to base buying decisions and a financial reward in the form of a rebate. A consumer can make purchases utilizing the Internet or do so in a conventional across-the-counter manner at the showroom. The rebates can be directed to various recipients or accounts such as a retirement account for the consumer or others such as the consumer's heirs.

It will be obvious to those skilled in the art to make various changes, alterations and modifications to the invention described herein. To the extent such changes, alterations and modifications do not depart from the spirit and scope of the system described, are intended to be encompassed therein.

I claim:

1. A system for delivery of goods and services to the consumer comprising:
(a) means for registering a consumer as a participant;
(b) information transmission means for transmitting to the participant product related information and information concerning showrooms convenient to the participant;
(c) a showroom located in a geographically convenient location which showroom displays various products for inspection and purchase by the participant;
(d) means for receiving and fulfilling an order from a participant; and
(e) means for crediting the participant with a rebate on qualified purchases.

2. The system of claim 1 wherein said information transmission means comprises a network of Internet-based computers.

3. The system of claim 1 wherein a plurality of showrooms are located at geographically diverse locations.

4. The system of claim 1 wherein the product-related information includes price, description and warranty information.

5. The system of claim 1 wherein the showroom provides print-based catalog information to the participant.

6. The system of claim 1 wherein an account is an investment account.

7. The system of claim 2 wherein the participant can access information concerning his or her account via the Internet.

8. The system of claim 2 wherein the participant can access order tracking information via the Internet.

9. The system of claim 1 wherein rebates are accumulated until a certain amount is reached at which time the rebates may be distributed as directed by the participant.

10. The system of claim 1 wherein additional loyalty incentives are provided the participant based on the participant's utilization of the system.

11. The system of claim 1 wherein participants utilizing service providers receive a rebate.

12. The system of claim 11 wherein the service providers are selected from the group consisting of insurance companies, physicians, lawyers, dentists, mortgage companies, banks and security dealers.

13. The system of claim 1 wherein the registering participant is issued a card with identification indicia.

14. The system of claim 1 wherein a registered participant may access the system by providing positive identification.

15. The system of claim 12 wherein the identification is by means of biometrics.

16. The system of claim 1 wherein the rebate amount on items purchased for immediate delivery is less the rebate amount on items for later order fulfillment.

17. The system of claim 1, wherein the card issued the participant is a SMART CARD®.

18. The system of claim 17 wherein the card does not permit credit purchases and wherein rebates are credited to payment of a credit card account of the participant.

19. The system of claim 1 wherein the participant may elect to receive account information via mailed statements.

20. The system of claim 1 wherein the consumer may inspect and purchase goods from area authorized product dealers.

21. The system of claim 1 wherein the participant may make payment by any of the following groups: Credit Card, Debit Card, Cash or Check.

22. The system of claim 9 wherein the rebates are directed to a checking account.

23. The system of claim 1 wherein the rebates are directed to a savings account.

24. The system of claim 1 wherein the participant can access information via the Internet in a selected language.

25. The system of claim 1 wherein said participant is provided a hand-held POS device which the participant can input product selection and delivery information.

26. The system of claim 25 wherein said participant may direct the POS device to fulfill the order immediately or at a later time.

27. The system of claim 1 wherein said participant is provided a purchase receipt indicating the value of the rebate at a future date.

28. The system of claim 1 wherein a participant may advertise goods and services for sale to other participants.

29. The system of claim 1 wherein said product-related information comprises an on-line auction.

30. A computer-based system for delivery of goods and services to a participant comprising:
(a) means for acquiring registration data for each participant;
(b) means for transmitting product and service information to a participant;
(c) means for responding to inquiry from participants concerning products and services;
(d) means for displaying goods for physical inspection by participant;
(e) means for receiving and processing orders from participants; and
(f) means for computing and crediting the participant with a rebate on qualified purchases.

31. The system of claim 30 wherein said rebate is directed to an investment account.

32. The system of claim 30 wherein a comprehensive and fully integrated computer and global communication systems implements, operates and administers the system.
